(19) United States
(12) Patent Application Publication
(10) Pub. No.: US 2004/0099989 A1
(43) Pub. Date: May 27, 2004

(54) Process for the production of composite moldings

(76) Inventors: Franz Josef Bohne, Leichlingen (DE); Reinhold Franzen, Leverkusen (DE); Hans-Detlef Arntz, Lohmar (DE)

Correspondence Address: BAYER POLYMERS LLC, 100 BAYER ROAD, PITTSBURGH, PA, 15205, US

(21) Appl. No.: 10/716,007

(22) Filed: Nov. 18, 2003

(30) Foreign Application Priority Data
Nov. 21, 2002 (DE) 10254361.5

(51) Int. Cl. B29C 45/14

(52) U.S. Cl. 264/255; 264/257

(57) ABSTRACT

The present invention relates to a process for producing composite moldings from soft elastic synthetic materials and hard polyurethanes.

### BACKGROUND OF THE INVENTION

The present invention relates to a process for producing composite moldings. The production of hybrid materials (composite parts) from polyurethane (PUR) is effected in such a way that a material having relatively high compressive strength is firstly generated which is combined in a second working procedure with a material of lower compressive strength (Polyurethane Kunststoffhandbuch 7, Carl Hanser Verlag, Munich-Vienna 1983, pages 261-262, 376-378, 412-414). Examples of this method of working include:

the enclosing in foam of wooden cores in window construction

the production of skis

the production of instrument panels for automobiles

the manufacture of shoes that are soled in two layers, with a compact outsole and a soft elastic midsole which by way of comfort element connects the leather upper to the outsole.

For the purpose of producing such composite elements from, for example, textile, flexible foam and a hard, compact carrier material, the following processes are utilised at the present time (Polyurethane Kunststofjhandbuch 7, Carl Hanser Verlag, Munich-Vienna, Edition 3, 1993, pages 245-246):

a) The flexible foam is generated in or behind a textile layer (i.e. a “foam in cover” process as described in, for example, DE-A 22 27 143) and, in a subsequent process step, is attached to a separately manufactured hard, compact carrier (by adhesive bonding, nailing, etc.).

b) The soft elastic material is directly applied as foam onto a separately produced carrier which is made of hard material, whereby, in order to attain optimal adhesion, it is necessary in most cases to undertake a pretreatment of the carrier. Such pretreatment includes, for example, degreasing, roughening, application of primer, etc. The resulting product can then be covered, in a second working step, with a textile which is ordinarily fixed to the hard carrier.

In the case of the process described under b), the lack of a bond between foam and textile results in design limitations and increased wear by virtue of the friction between the various materials.

The disadvantages of the processes according to both processes a) and b) include the fact that the additional process steps are necessary for the attachment of the hard carrier or textile, and as a result of the storage, high costs arise. These factors make the processes uneconomic.

Accordingly, the object was to make available a technically simple process for producing composite parts without the aforementioned disadvantages.

Surprisingly, this was possible to achieve by producing a soft elastic molding in a first step, which optionally has a textile covering or a film, and reinforcing the molding in a second step with a hard PUR without permanently deforming the soft elastic molding in this step (e.g. by virtue of the process heat liberated and/or the pressure arising).

### SUMMARY OF THE INVENTION

The present invention provides a process for producing composite moldings. This process comprises:

a) optionally, in a first step, inserting or placing a film (e.g. polycarbonate film, polyvinyl chloride film or thermoplastic polyurethane film) or a cloth (textile or leather) into a mold,

b) introducing or generating a soft elastic synthetic material (e.g. PUR-gel or an elastomer) having low hardness, preferably from 1 Shore 00 (according to ASTM-D 2240) to 100 Shore A (according to DIN 53 505), into the mold,

c) enlarging the volume of the mold from b) after a predetermined dwell-time which is based on the synthetic material in b) above, and

d) generating a hard polyurethane material which has a density from 800 kg/m³ to 1600 kg m³, preferably from 1050 kg/m³ to 1250 kg/m³, and a hardness from 20 Shore A (according to DIN 53 505) to 100 Shore D (according to DIN 53 505), in an unpressurized manner in the available volume of the mold,

wherein the hardness of the soft elastic synthetic material formed in b) is at least 10% of the hardness of the polyurethane formed in d).

### DETAILED DESCRIPTION OF THE INVENTION

In the process according to the invention, hard materials such as those which arise, for example, as a result of the processing of polyol mixtures (OH number greater than 200 and functionality of greater than 2) and organic polyisocynates (e.g. Baydur® GS or Baydur® CSP from Bayer AG), can be rationally and simply combined with soft elastic products such as are obtained, for example, by the conversion of soft synthetic materials, preferably polyurethanes (e.g. Bayflex® systems or Bayfit® systems from Bayer AG), so as to form composite moldings with outstanding bond properties. The bond strengths that are achieved between the individual components of the composite molding exceed the strength of the weaker material in the given case, and these can be achieved without an additional pretreatment of the surfaces of the synthetic materials that are employed or generated.

The hard polyurethane material is preferably produced by reacting an organic polyisocyanate, preferably an MDI based polyisocyanate with an NCO group content of greater 20% by weight and a polyol mixture with an OH number of greater than 200 and a functionality of greater than 2.

The composite moldings that are produced in accordance with the invention can be used in the leisure, furniture, medical and automotive fields and also as constructional elements with a safety aspect.

The invention will be elucidated in more detail on the basis of the following Examples.

### EXAMPLES

The following components were used in the working examples:

| | |
|---|---|
| Polvol Mixture 1: | a polyether polyol mixture characterized by an OH number |
| | of 28 and a functionality in the range of 2.2 to 2.5 |
| | containing 3% by weight of water as blowing agent as well |
| | as surfactants and catalysts (commercially available as |
| | Bayfit ® VP PU 44 BM 04 from Bayer AG). |
| Polvol Mixture 2: | a polyether polyol mixture characterized by an OH number |
| | of 160 and a functionality in the range 2.0 to 2.2 |
| | containing less than 0.1% by weight of water and 5% by |
| | weight of pentane as blowing agent as well as surfactants |
| | and catalysts (commercially available as Bayflex ® 5965 I |
| | from Bayer AG). |
| Polvol Mixture 3: | a polyether polyol mixture characterized by an OH number |
| | of 355 and a functionality of greater than 2.5 as well as |
| | surfactants and catalysts (commercially available as |
| | Baydur ® 6700 Z from Bayer AG). |
| Polvol Mixture 4: | a polyether polyol mixture characterized by an OH number |
| | of 375 and a functionality greater than 3.0 as well as |
| | surfactants and catalysts (commerically available as |
| | Baydur ® VP PU 85 BD 04 from Bayer AG). |
| Isocyanate 1: | a diphenyl methane diisocyanate prepolymer (product of |
| | MDI and a polyether (OH number 39) started with |
| | sorbitol) with an NCO group content of 30.3% by weight |
| | and a functionality of 2.3 (commercially available as |
| | Desmodur ® VP PU 20 IK 45 from Bayer AG). |
| Isocyanate 2: | a mixture of polymeric and monomeric diphenyl methane |
| | diisocyanate with an NCO group content of 31.5% by |
| | weight and a functionality of 2.9 (commercially available |
| | as Desmodur ® 44 V 20 L from Bayer AG). |
| Isocyanate 3: | a diphenyl methane diisocyanate prepolymer (product of |
| | MDI and a polyether (OH number 800)) started with |
| | propylene glycol) with an NCO group content of 28.2% by |
| | weight and a functionality of 2.3 (commercially available |
| | as Desmodur ® 44 P 90 from Bayer AG). |
| Isocyanate 4: | a diphenyl methane diisocyanate prepolymer (product of |
| | MDI and pentaerythritol polyester (OH number 51)) with |
| | an NCO group content of 27.9% by weight and |
| | functionality of 2.9 (commercially available as Desmodur ® |
| | VP PU 26 BD 14 from Bayer AG). |

### Example 1

In a mold (having a volume of 2000 cm³) a polyurethane was generated that was produced from the following components:

100 parts by weight of Polyol Mixture 1

48 parts by weight of Isocyanate 1

The converted quantity amounted to a total of 110 g. The density of the resultant molded part was 55 kg/m³. The polyurethane exhibited a hardness of 20 Shore 00.

After a dwell-time of 10 minutes, the volume of the mold was enlarged by 200 cm³ by replacing the cover of the mold. In this free volume within the mold, a polyurethane was produced that was generated by conversion of the following components:

100 parts by weight of Polyol Mixture 3

97 parts by weight of Isocyanate 2

A total of 230 g were converted. The density of the resultant molded part was 1150 kg/m³. The polyurethane exhibited a hardness of 75 Shore D.

### Example 2

Example 1 was repeated, except that instead of the second hard polyurethane from Example 1, a polyurethane was generated from the following components:

100 parts by weight of Polyol Mixture 2

48 parts by weight of Isocyanate 3

The converted quantity amounted to a total of 230 g, and the density of the resultant molded part was 1150 kg/m³. The polyurethane had a hardness of 80 Shore A (or 20 Shore D).

### Example 3

First, a textile layer was inserted into a mold (with a volume of 19,200 cm³), and after this a polyurethane was generated in this mold from the following components:

100 parts by weight of Polyol Mixture 1

48 parts by weight of Isocyanate 1

The converted quantity amounted to a total of 1050 g, and the density of the resultant molded part was 55 kg/m³. The polyurethane exhibited a hardness of 20 Shore 00.

After a dwell-time of 10 minutes, the volume of the mold was enlarged by 3200 cm³ by replacing the cover of the mold. In this free volume, a polyurethane was produced from the following components:

100 parts by weight of Polyol Mixture 4

48 parts by weight of Isocyanate 4

A total of 3520 g were converted. The density of the resultant molded part was 1100 kg/m³, and the resultant part exhibited a hardness of 75 Shore D.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing composite moldings, comprising
a) optionally, inserting a film or a cloth into a mold,
b) forming a soft elastic synthetic material having low hardness, from 1 Shore 00 (according to ASTM-D 2240) to 100 Shore A (according to DIN 53 505) in the mold,
c) enlarging the volume of the mold from b) after a predetermined dwell-time based on the soft elastic synthetic material in b), and
d) forming a hard polyurethane having a density of from 800 kg/m³ to 1600 kg/m³ and having a hardness of from 20 Shore A (according to DIN 53 505) to 100 Shore D (according to DIN 53 505) in an unpressurized manner in the available volume of the mold,
wherein the hardness of the soft elastic synthetic material formed in b) is at least 10% of the hardness of the polyurethane formed in d).

2. The process of claim 1, wherein the hard polyurethane formed in d) has a density of from 1050 kg/m³ to 1250 kg/m³.
